(19) United States
(12) Patent Application Publication
(10) Pub. No.: US 2023/0325630 A1
(43) Pub. Date: Oct. 12, 2023

(54) GRAPH LEARNING-BASED SYSTEM WITH UPDATED VECTORS

(71) Applicant: VISA INTERNATIONAL SERVICE ASSOCIATION, San Francisco, CA (US)

(72) Inventors: Yuhang Wu, Foster City, CA (US); Mahsa Shafaei, San Francisco, CA (US); Mina Ghashami, San Francisco, CA (US); Fei Wang, Fremont, CA (US)

(73) Assignee: VISA INTERNATIONAL SERVICE ASSOCIATION, San Francisco, CA (US)

(21) Appl. No.: 18/044,552

(22) PCT Filed: Sep. 20, 2021
(86) PCT No.: PCT/US2021/051147

§ 371 Date: Mar. 8, 2023

Related U.S. Application Data
(60) Provisional application No. 63/081,804, filed on Sep. 22, 2020.

(51) Int. Cl. G06N 3/044; G06N 3/045; G06N 3/08

(52) U.S. Cl. CPC G06N 3/044; G06N 3/045; G06N 3/08

(57) ABSTRACT

A method includes extracting, by an analysis computer, a dataset including initial vector representations for each of a plurality of user nodes and for each of a plurality of resource provider nodes. The analysis computer can then generate updated vector representations as new interaction data arrives over time, and use them to perform predictions of future interactions.

### CROSS-REFERENCE TO RELATED APPLICATIONS

This application claims the benefit of U.S. Provisional Application No. 63/081,804, filed Sep. 22, 2020, which is herein incorporated by reference in its entirety for all purposes.

### BACKGROUND

Certain interactions take place between two different types of entities; resource providers and users. Interactions can be described by a number of parameters, which can be referred to as dimensions. Examples of dimensions include the type of user device, a resource provider location, an interaction channel (e.g., in-person, online, over the phone, etc.).

Interactions are either initiated by the resource provider or the user. Examples of resource provider-initiated transactions are recurring subscription service interactions. Examples of user-initiated transactions are a user physically presenting a user device to a resource provider terminal or entering user device information at a website.

Often when a resource provider-initiated interaction is rejected, the resource provider may retry the interaction until it is approved. This negatively uses processing power, incurs processing costs for the resource provider, and lowers the overall approval rate of the resource provider's interactions.

Further, conventional interaction prediction systems can be resource intensive, since they can involve the re-creation or re-formatting of an entire existing prediction model as new data is obtained. This can require a significant amount of computing resources, especially in situations where there can be millions or billions of interactions, each interaction including multiple features.

Embodiments of the invention address these and other problems individually and collectively.

### BRIEF SUMMARY

One embodiment is related to a method comprising: receiving, by an analysis computer, a graph comprising a plurality of user nodes for a plurality of users, a plurality of resource provider nodes for a plurality of resource providers, and a plurality of interaction edges between the plurality of user nodes and the plurality of resource provider nodes, the interaction edges representing a plurality of interactions between the plurality of users and the plurality of resource providers; extracting, by the analysis computer, a dataset including initial vector representations for each of the plurality of user nodes and for each of the plurality of resource provider nodes; generating, by the analysis computer, using a first recurrent neural network and an initial vector representation for a first user node from the plurality of user nodes, an updated vector representation for the first user node in response to a new interaction involving the first user node; performing, by the analysis computer, a first prediction of a future interaction based on the updated vector representation for the first user node; and performing, by the analysis computer, an action based on the future interaction.

Another embodiment is related to an analysis computer comprising: a processor; and a computer readable medium coupled to the processor, the computer readable medium comprising code, executable by the processor, for implementing the method described above.

Further details regarding embodiments of the invention can be found in the Detailed Description and the Figures.

### BRIEF DESCRIPTION OF THE DRAWINGS

FIG. 1 shows block diagram of a system, according to some embodiments.

FIG. 2 shows a block diagram of an analysis computer, according to some embodiments.

FIG. 3 shows a graph of an example of interaction data modeled as a bipartite graph, according to some embodiments.

FIG. 4 shows an illustration of interconnected Recurrent Neural Network equations, according to some embodiments.

FIG. 5 shows a bipartite graph illust

[symbol]

according to some embodiments.

FIG. 6 shows a bipartite graph with interaction data separated by outcome, according to some embodiments.

FIG. 7 shows an illustration of interconnected Recurrent Neural Network equations with additional input variables, according to some embodiments.

FIG. 8 shows a flow diagram illustrating a dynamic graph representation process, according to some embodiments.

### DETAILED DESCRIPTION

Prior to describing embodiments of the disclosure, some terms may be described in detail.

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, which are collections of artificial “neurons” that perform functions by activating in response to inputs. In some embodiments, a neural network can include a convolutional neural network, a recurrent neural network, etc.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model [symbol] keywords “news,” “propaganda,” and “information.” An analysis computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a numerical representation of relative happiness, etc. Feature vectors can be represented and stored electronically in a feature store. Further, a feature vector can be normalized, i.e., be made to have unit magnitude. As an example, the feature vector (12, 15, 22, 5) corresponding to “LOVE” could be normalized to approximately (0.40, 0.51, 0.74, 0.17).

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

A “topological graph” can include a representation of a graph in a plane of distinct vertices connected by edges. The distinct vertices in a topological graph may be referred to as “nodes.” Each node may represent specific information for an event or may represent specific information for a profile of

[symbol]

related to one another by a set of edges, E. An “edge” may be described as an unordered pair composed of two nodes as a subset of the graph G=(V, E), where is G is a graph comprising a set V of vertices (nodes) connected by a set of edges E. For example, a topological graph may represent a transaction network in which a node representing a transaction may be connected by edges to one or more nodes that are related to the transaction, such as nodes representing information of a device, a user, a transaction type, etc. An edge may be associated with a numerical value, referred to as a “weight,” that may be assigned to the pairwise connection between the two nodes. The edge weight may be identified as a strength of connectivity between two nodes and/or may be related to a cost or distance, as it often represents a quantity that is required to move from one node to the next. In some embodiments, a graph can be a dynamic graph, which may change over time. For example, nodes and/or edges may be added to and/or removed from the graph. A topological graph can be a “bipartite graph” with two distinct types of categories of nodes. For example, a bipartite graph can include user nodes for users and resource provider nodes for resource providers. More specifically, a user can be a consumer and a resource provider can be a merchant.

A “subgraph” or “sub-graph” can include a graph formed from a subset of elements of a larger graph. The elements may include vertices and connecting edges, and the subset may be a set of nodes and edges selected amongst the entire set of nodes and edges for the larger graph. For example, a plurality of subgraph can be formed by randomly sampling graph data, wherein each of the random samples can be a subgraph. Each subgraph can overlap another subgraph formed from the same larger graph.

A “community” can include a group of nodes in a graph that are densely connected within the group. A community may be a subgraph or a portion/derivative thereof and a subgraph may or may not be a community and/or comprise one or more communities. A community may be identified from a graph using a graph learning algorithm, such as a graph learning algorithm for mapping protein complexes. Communities identified using historical data can be used to classify new data for making predictions. For example, identifying communities can be used as part of a machine learning process, in which predictions about infor [symbol] on their relation to one another.

“Graph data” can include data represented as a topological graph. For example, graph data can include data represented by a plurality of nodes and edges. Graph data can include any suitable data (e.g., interaction data, communication data, review data, network data, etc.).

A “graph snapshot” can include graph data within a time range. For example a graph snapshot may include graph data occurring during a 3 day, 1 week, 2 month, etc. period of time.

A “graph context prediction” can include any suitable prediction based on graph data. In some embodiments, the prediction can relate to the context of at least some part of the graph or the graph data. For example, if the graph data was formed from weather data, then the prediction may relate to predicting the weather in a particular location. In some embodiments, a graph context prediction may be made by a machine learning model that is formed using final node representations, which may correspond to data from second data sets. In some embodiments, the graph context prediction may be a classification by a machine learning model of some input data.

“Vector representations” can include vectors which represent something. In some embodiments, vector representations can include vectors which represent nodes from graph data in a vector space. In some embodiments, vector representations can include embeddings.

A “dataset” can include a collection of related sets of information that can be composed of separate elements but can be manipulated as a unit by a computer. In some embodiments, a dataset can include a plurality of vectors.

A “server computer” may include a powerful computer or cluster of computers. For example, the server computer can be a large mainframe, a minicomputer cluster, or a group of servers functioning as a unit. In one example, the server computer may be a database server coupled to a web server. The server computer may comprise one or more computational apparatuses and may use any of a variety of computing structures, arrangements, and compilations for servicing the requests from one or more client computers.

A “memory” may include any suitab [symbol] electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “processor” can include to any suitable data computation device or devices. A processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

### I. Introduction

Embodiments of the invention provide a novel machine learning based system to predict future interactions, as well as the probability that future interactions will be approved or declined. A machine learning-based engine can predict approval probability of an interaction, and can then advise resource providers so that the resource providers can take corresponding actions (e.g., do not resubmit an interaction until later) to save processing and computation costs. This system can help resource providers to refrain from retrying declined interactions when their approval chance is low. In addition, the system can assist a recommendation system by providing insights on a next resource provider a user is likely to have a successful interaction with.

Embodiments of the disclosure can operate on dynamic graphs. An initial set of vector representations of nodes can be prepared (e.g., through structural graph learning). Then, the vector representations can be updated as new interaction data arrives. Instead of, for example, recreating the entire set of vectors, each vector representation can be updated when it is involved with a new interaction. The updated vector representations can be used as inputs for prediction functions designed to predict subsequent interaction locations, interaction characteristics, and interaction outcomes.

A group of linked recurrent neural networks can b [symbol] they can be trained together using historical interaction data.

Embodiments of the invention include a graph neural network (GNN) based framework that uses multiple recurrent neural networks (RNNs) to model and predict the future resource providers that a particular user may interact with. Embodiments of the invention may also product future interaction approval probability for such interactions.

In some embodiments, the GNN model leverages information from the dynamic temporal graph. Additionally, in some embodiments, in addition to aggregating information aggregate from immediately-neighboring nodes, information can be utilized from two hop (or more) neighbor nodes. This can further improve the prediction performance.

According to some embodiments, resource provider and user embeddings are generated to represent their status. These embeddings can be used for one or more downstream tasks, such as fraud detection, community discovery, etc.

Embodiments can be generalized to model other important parties in the interaction data, such as an issuer bank and/or acquire bank, through additional RNNs.

A. System Overview

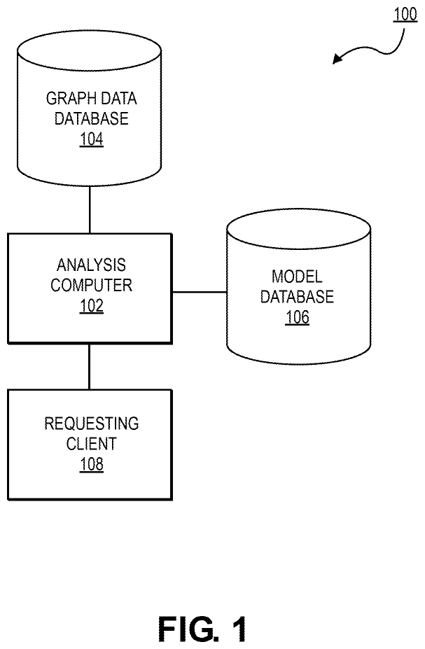

FIG. 1 shows a block diagram of a system 100 comprising a number of components according to some embodiments. The system 100 comprises an analysis computer 102, a graph data database 104, a model database 106, and a client device 108. The analysis computer 102 can be in operative communication with the graph data database 104, the model database 106, and the client device 108 (e.g., a remote computer).

For simplicity of illustration, a certain number of components are shown in FIG. 1. It is understood, however, that embodiments of the disclosure may include more than one of each component. In addition, some embodiments of the disclosure may include fewer than or greater than all of the components shown in FIG. 1.

Messages between the devices of system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO [symbol] communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The graph data database 104 may securely store graph data. The graph data database 104 can store topological graph data which may be updated as new data is received.

The model database 106 can securely store models. For example, the analysis computer 102 can create a model (e.g., a machine learning model) and can store the model in the model database 106. In some embodiments, the graph data database 104 and the model database 106 may be conventional, fault tolerant, relational, scalable, secure databases such as those commercially available from Oracle™, Sybase™, etc.

The analysis computer 102 can be capable of performing dynamic graph representation learning via recurrent neural networks as described herein. The analysis computer 102 can be capable of retrieving graph data from the graph data database 104, and then processing the graph data with a machine learning model. The analysis computer 102 may regularly update graph data as well as be capable of performing graph context prediction with the graph data, which is described in further detail herein.

The client device 108 can include any suitable device external to the analysis computer 102. In some embodiments, the client device 108 may receive outputs and/or predictions made by the analysis computer 102. In other embodiments, the client device 108 can transmit a request (e.g., a prediction request) to the analysis computer 102. The request can include request data regarding a model. The client device 108 can request the analysis computer 102 to run a model to, for example, predict whether or not two nodes of the graph da [symbol] future. After receiving the request comprising request data, the analysis computer 102 can determine output data. For example, the analysis computer 102 can input the request data into the model to determine output data, output by the model. The analysis computer 102 may then provide the output data to the client device 108. In some embodiments, the analysis computer 102 can use the model to predict a client device 108 and then push the output data to the client device 108.

B. Analysis Computer

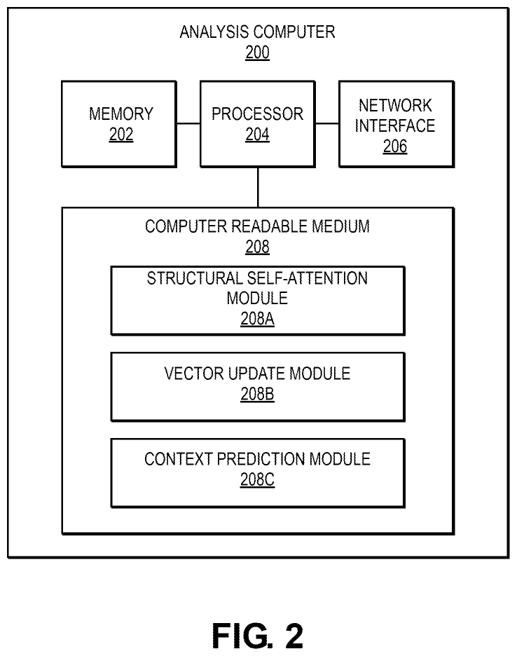

FIG. 2 shows a block diagram of an analysis computer 200 according to embodiments. The exemplary analysis computer 200 may comprise a processor 204. The processor 204 may be coupled to a memory 202, a network interface 206, input elements 210, output elements 212, and a computer readable medium 208. The computer readable medium 208 can comprise a graph structure learning module 208A, a temporal self-attention module 208B, and a context prediction module 208C.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. For example, the memory 202 can store graph data, vectors, datasets, etc.

The computer readable medium 208 may comprise code, executable by the processor 204, for performing a method comprising: receiving, by an analysis computer, a graph comprising a plurality of user nodes for a plurality of users, a plurality of resource provider nodes for a plurality of resource providers, and a plurality of interaction edges between the plurality of user nodes and the plurality of resource provider nodes, the interaction edges representing a plurality of interactions between the plurality of users and the plurality of resource providers; extracting, by the analysis computer, a dataset including initial vector representations for each of the plurality of user nodes and for each of the plurality of resource provider nodes; generating, by the analysis computer, using a first recurrent neural network and an initial vector representation for a first user node from the plurality of user nodes, an updated vector representation for the first user node in response to a new interaction involving the first user node; performing, by the analysis computer, a first prediction of a future interaction based on the updated vector representation for t [symbol] the analysis computer, an action based on the future interaction.

The graph structure learning module 208A may comprise code or software, executable by the processor 204, for performing graph structure learning. An example of graph structure learning is structural self-attention. For example, the graph structure learning module 208A, in conjunction with the processor 204, can perform structure self-attention by attending over immediate neighboring nodes of a particular node (e.g., node v). For example, the graph structure learning module 208A, in conjunction with the processor 204, can attend over the immediate neighboring nodes by determining attention weights (e.g., in an attentional neural network) as a function of the input nodes. In some embodiments, the graph structure learning module 208A, in conjunction with the processor 204, can determine vector representations for each node of a graph.

For example, the graph structure learning module 208A, in conjunction with the processor 204, can receive an initial graph of graph data. The graph data may be communication data which includes particular users (e.g., represented as nodes), such as users and resource providers, and communications between the users (e.g., represented as edges). The graph structure learning module 208A, in conjunction with the processor 204, can first determine what nodes are connected to a first node (e.g., a first user in the communication network). The nodes connected (via edges) to the first user can be neighboring nodes. The neighboring nodes of the first node can be used when determining the embedding of the first node. In such a way, attention may be placed on the first node's neighboring nodes when determining the vector representation of the first node, thus capturing structural patterns in the graph data.

The vector update module 208A may comprise code or software, executable by the processor 204, for updating vectors. The vector update module 208A, in conjunction with the processor 204, can receive initial vector representations from the graph structure learning module 208A, and then generate updated vector representations based on the initial vector representations and new interaction data. The vector update module 208A, in conjunction with the processor 204, can generate updated vector representations using one or more vector update equations with trainable weight parameters.

In some embodiments, the analysis [symbol] of model using at least the updated vector dataset. For example, the model can include a machine learning model (e.g., support vector machines (SVMs), artificial neural networks, decision trees, Bayesian networks, genetic algorithms, etc.). In some embodiments, the model can include a mathematical description of a system or process to assist calculations and predictions (e.g., a fraud model, an anomaly detection model, etc.).

For example, analysis computer 200 can create a model, which may be a statistical model, which can be used to predict unknown information from known information. For example, the analysis computer 200 can include a set of instructions for generating a regression line from training data (supervised learning) or a set of instructions for grouping data into clusters of different classifications of data based on similarity, connectivity, and/or distance between data points (unsupervised learning). The regression line or data clusters can then be used as a model for predicting unknown information from known information.

Once the model has been built from at least the updated dataset by the analysis computer, the model may be used to generate a predicted output from a request by the context prediction module 208C, in conjunction with the processor 204. The context prediction module 208C can include may comprise code or software, executable by the processor 204, for performing context prediction. For example, the received request may be a request for a prediction associated with presented data. For example, the request may be a request for predicting a subsequent interaction for a certain user (e.g., user or resource provider), and/or a prediction that the future interaction will be classified as approved or declined, or for a recommendation for a user.

In some embodiments, the analysis computer 200 can create a model that trains a set of equations for updating vector representations based on new interactions, and based on the passage of time without new interactions. These equations can be used to predict a future version of a vector representation of a user and/or resource provider, which can then be used to determine what interactions and activities the user and/or resource provider may perform.

The graph context prediction module 208C, in conjunction with the processor 204, can perform any suitable prediction based on the context of the graph data. For example, the analysis computer 200 ca [symbol] graph data. In some embodiments, the prediction can relate to the context of the graph to which the graph data is associated. The analysis computer 200 can, for example, perform graph context prediction to determine a prediction of whether or not a user will transact at some point in the next week, and with which specific resource provider, and whether that interaction will be approved or declined. As an illustrative example, the updated vector dataset, determined by the vector update module 208B, in conjunction with the processor 204, can be used to train a neural network. For example, the updated vector dataset may correspond to graph data comprising users and resource providers connected via interactions. The neural network can be trained in any suitable manner with the updated vector dataset. In some embodiments, the neural network can be trained to classify input vectors as either, for example, approved or declined. As another example, the neural network can be trained to predict whether or not two nodes will be connected via an edge (e.g., whether a particular user and resource provider transact) in the future.

The network interface 206 may include an interface that can allow the analysis computer 200 to communicate with external computers. The network interface 206 may enable the analysis computer 200 to communicate data to and from another device (e.g., a client device, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

### II. Problem Modeling

Embodiments of the invention can use historical interaction information for a set of users and resource providers to learn their interaction patterns, which can then be used to predict whether a future interaction will succeed or fail.

A dataset of interactions Tᵣ can be represented as shown below:

Tᵣ=(cᵣ,mᵣ,tᵣ,fᵣ)

Where Tᵣ represents the interaction (for a set r of interactions), cᵣ represents a user that participated in the interaction, mᵣ represents a resource provider that participated in the interaction, tᵣ represents the time of the interaction, and fᵣ represents the feature vector of the interaction. The feature vector can include value dimensions for any suitable number of interaction features.

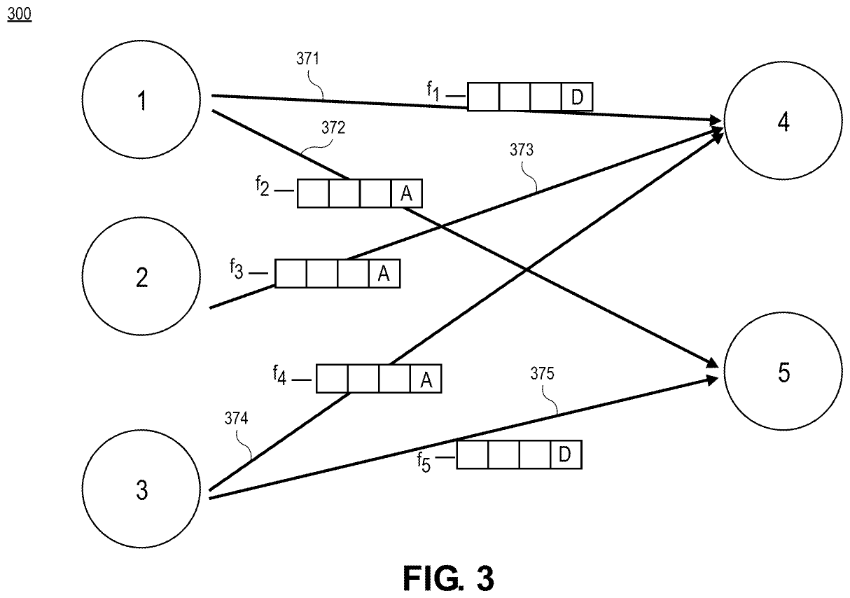

The interaction dataset can be modeled in the form of a bipartite graph. An example of interaction data modeled as a bipartite graph 300 is shown in FIG. 3. The bipartite graph 300 includes nodes and edges between the nodes. Two types of nodes are present: user nodes representing specific users and resource provider nodes representing specific resource providers. The user nodes include nodes 1-3, and the resource provider nodes include nodes 4-5. From the interaction dataset, each interaction is shown in the bipartite graph 300 as an edge. Each edge is a line between two nodes, where the nodes represent participants of the interaction. For example, interaction edge 371 takes place between user node 1 and resource provider node 4, interaction edge 372 takes place between user node 1 and resource provider node 5, interaction edge 373 takes place between user node 2 and resource provider node 4, interaction edge 374 takes place between user node 3 and resource provider node 4, and interaction edge 375 takes place between user node 3 and resource provider node 5.

Each interaction edge in the graph 300 can have an associated feature vector fᵣ containing values for different features for that interaction. Transaction features can include an interaction amount, the type of good or service, an interaction mode (e.g., in person or online), a date, a time, an ecommerce indicator, a user device type (e.g., credit or debit), a payment processor, an interaction status (e.g., approved or declined), and/or any other suitable information associated with the interaction.

A interaction status feature indicate [symbol] approved or declined. For illustrative purposes, feature vectors with four feature dimensions are shown next to each interaction edge. In this example, the fourth feature dimension is the interaction status, where “A” indicates that the interaction was approved, and “D” indicates that the interaction was declined. The first, second, and third feature dimensions, while left blank in the figure, can represent any suitable type of feature.

Based on the nature of interactions, the bipartite graph 300 has two key properties. Firstly, the bipartite graph 300 is temporal, as every edge has an associated time (i.e. time of the interaction). Secondly, the bipartite graph 300 is dynamic and evolves over time, such that additional nodes and/or edges are added to the bipartite graph 300 when additional interactions occur.

Embodiments of the invention can generate vector representations of each node (such as for a node of a person) based on node and edge characteristics from the graph data. The vector representations can be updated when new interactions occur, and can be used to predict future interactions. For example, for a certain user, it can be predicted when will a future interaction take place, with which resource provider will the user transact, etc. Additionally, for each predicted future interaction, embodiments can predict an outcome or status for that interaction (e.g., approve or decline). Further, a resource provider can be informed about predicted interactions and predicted outcomes. For example, if a certain interaction with a certain user is predicted to be declined, the analysis computer can send a notification to the resource provider, and the resource can then determine to not submit and/or repeatedly resubmit the interaction for approval at all or until at a later time, thereby saving processing resources.

Embodiments have a number of additional advantages. For example, in the past, one can have a large dataset of graphs nodes of transaction data (e.g., including nodes of resource providers and nodes of users, and edges that can describe their interactions). This dataset can be transformed into vectors that describe the relationships between nodes and edges in a graph. As new data is received, these vectors may no longer be accurate as users and resource providers are continuously performing interactions over time. One way to alleviate this problem is to start the process all over again, and re-generate the vect [symbol] includes the new data.

However, embodiments of the invention do not need to do this. Instead, embodiments of the invention can create specific vectors for specific nodes, and update each vector individually as new data relevant to that vector is obtained. Each vector can be updated based upon data such as any data relating to new transactions, as well as interactions with proximate nodes (e.g., one-hop or two-hop nodes). This vector update process is an efficient way to create a model that incorporates current and past interaction activity.

### III. Dataset Preprocessing

According to some embodiments, the dataset can be preprocessed in preparation for the data analysis. For example, the interactions can be sorted and arranged based on time (e.g., oldest to newest).

Additionally, the dataset may be unbalanced in terms of the interaction status. Typically, about 3% of the interactions are declined interactions. As a result of most interactions in the dataset being approved, it may be difficult for the analysis computer to identify patterns associated with only declined interactions. To avoid this problem, the interaction data may be filtered and reduced to collect the same number of each class (e.g., approved and declined) to make a balanced dataset. For the larger class (i.e., approved interactions), the dataset is sampled to collect instances of approved interactions that span from the beginning of the dataset timeframe to the end of the dataset timeframe in order to preserve the distribution of the data over time.

Further, the feature vectors may include feature values with a wide range of real numbers. As a result, some of the feature values for certain interactions may be significantly larger than values for the same features in other interactions. Relatively larger values can dominate other values for the same feature, and as a result may skew the data and results. To avoid this issue, we standardize (or normalize) the feature vectors using the following formula.

Z=x−μ/σ

Where Z represents a modified feature value, x is original feature value, μ is the minimum value for that certain feature, and σ is difference between the maximum and the minimum values of that feature. This can mo [symbol] they are between 0 and 1.

### IV. Example Dataset

An example dataset and some associated statistics will now be discussed for illustrative purposes. Table 1, shown below, gives an example dataset with 9032 users, 681 resource providers, and 68,912 interactions between those users and resource providers

TABLE 1
Number of unique users, resource providers and interactions
All data

| Number | Number of | |
|---|---|---|
| of unique | unique resource | Number of |
| users | providers | interactions |
| 9032 | 681 | 68912 |

Table 2, shown below, divides the users and resource providers in the dataset based on degrees. A “degree” is the number of edges connected to each user node or resource provider node. The dataset is divided into categories of degree less than 10, degree between 10 and 100, and degree greater than 100. In some embodiments, a degree can represent the number of interactions in which that user or resource provider participates. Alternatively, in some scenarios, the degree can represent the number of entities with which that user or resource provider has interacted.

TABLE 2
Degree categories for users and resource providers

| Degree | <10 | 10< & <100 | >100 | Total |
|---|---|---|---|---|
| # of users | 7,664 | 1,310 | 58 | 9032 |
| # of resource providers | 489 | 134 | 57 | 681 |

Table 3, shown below, divides the i [symbol] status (i.e., approved or declined).

TABLE 3
distribution of interactions in declined and approved class

| | Approved interactions | Declined interaction |
|---|---|---|
| Number of interactions | 32,264 | 36,648 |

This data can be utilized for generating vector representations for each user and resource provider. It can also be used as training data for training the neural network to determine future interactions and outcomes, as discussed below.

### V. Learning Embeddings

In some embodiments, an analysis computer can be configured to determine embeddings of graph data. For example, the analysis computer can determine an initial set of vectors that represent each node in the graph data. The analysis computer can also update each vector as time progresses and as additional interactions take place. The vector representations can then be used in graph context prediction.

As an illustrative example, graph data can include interaction data (e.g., interaction data, etc.). The graph data can include any suitable number of nodes and edges. The nodes of the graph data can represent users and resource providers. Edges may connect a user node to a resource provider node when the two have performed an interaction.

A. Initial Embeddings

To determine an initial graph representation, the analysis computer can retrieve the graph data from a graph data database. The analysis computer can then extract an initial dataset using a graph structure learning module. The initial dataset can include, for example, initial vector representations for each user node and resource provider node. The initial vector representations can be in a vector space which may represent characteristics of the graph data. Structural properties (and possibly attributes) of a node's neighborhood can be encoded into a low-dimensional vector. For example, if two nodes of the graph are similar (e. [symbol] then the vectors representing the two nodes may be similar in the vector space.

Extraction of the initial dataset can be performed through any suitable means, according to embodiments. For example, embodiments can utilize Graph Neural Network techniques, trainable neighborhood aggregation functions, attention mechanisms, random walk-based methods (e.g., Deepwalk) that learn node embeddings by maximizing the co-occurrence probability of nodes appearing within a window in a random walk, or any other suitable techniques. An underlying principle of attention mechanisms can be to learn a function that aggregates a variable-sized input, while focusing on the parts most relevant to a certain context. When the attention mechanism uses a single sequence as both the inputs and the context, it can be referred to as self-attention. Though attention mechanisms were initially designed to facilitate Recurrent Neural Networks (RNNs) to capture long-term dependencies, recent work by (Vaswani et al., (2017)) demonstrate that a fully self-attentional network itself can achieve state-of-the-art performance in machine translation tasks. (Velickovic et al., (2018)) extend self-attention on graphs by enabling each node to attend over its neighbors, achieving state-of-the-art results for semi-supervised node classification tasks in static graphs.

As an example, initial vector representations can be determined though a self-attentional neural network, where the analysis computer determines how much attention (e.g., weight) to give to a node's neighboring nodes, based on their influence on the node. The analysis computer can, for each node, determine a vector based on a node's neighboring nodes (e.g., local structure). For example, during the self-attentional process, the analysis computer can determine an vector representation for a first user node. The analysis computer can determine values which represent the attention which can be placed on links between the first user node and each resource provider node that the first user node is connected to. In one example, the first user node may be connected via edges to three resource provider nodes including a first resource provider located in San Francisco that provides resources of groceries, a second resource provider located in San Francisco that provides resources of electronics, and a third resource provider located in New York that provides resources of digital books. The analysis computer can attend over the nodes to determine the vector representation of the first user node. For example, the first user node may be associated with a location of San Francisco as wi [symbol] community group. The analysis computer can determine values using the self-attentional neural network, where the inputs can include the first user node and the neighboring nodes, as described in further detail herein. The output of the neural network can include a vector including values representing a degree of how closely the first user node relates to each of the input nodes. For example, in some embodiments, the first user node may most closely relate to itself, as it shares all of its own characteristics. The first user node can then relate to the second resource provider (San Francisco, electronics), the first resource provider (San Francisco, groceries), and the third resource provider (New York, digital books), in descending order of degree of likeness, since the first user node is associated with San Francisco and electronics.

B. Update Embeddings based on New Interaction

The initial dataset of embeddings may be generated based on initial graph data that represents nodes and edges from an initial timeframe (e.g., a first day, week, month, year, etc.). As additional data is created, such as new nodes and/or edges, the graph can change. Instead of creating an entirely new set of embeddings for the new or updated graph, embodiments can update the initial dataset of embeddings.

Continuing the previous example, during a vector update process, the analysis computer can receive additional information about subsequent interactions between the user and the same of other resource providers. For example, the first user node may now also be connected via edges to two more resource provider nodes including a fourth resource provider located in San Francisco that provides resources of sporting goods, and a fifth resource provider located in Oakland that provides resources of clothing. The analysis computer can generate an updated vector representation of the first user node based on the new interaction data. For example, the first user node may now be more strongly associated with a location of San Francisco as well as newly associated with a sporting goods community group.

The analysis computer can utilize an additional neural network designed to update the vector representations of nodes. The neural network can be designed to include certain inputs such as the previous user vector representation, the previous resource provider vector representation, the amount of time elapsed since the most recent interaction, features of the transaction, and any other suitable details. Including these details as inputs can train the network to id [symbol] status of a user or resource provider. For example, when the user interacts with the fifth resource provider in Oakland, that fifth resource provider's embedding is used as an input to update the user's embedding. This can reflect that the relationship with the new resource provider can be indicative of some change in the user's status or behaviors. The output of the neural network can include a new vector representing a degrees of relation to other nodes.

In some embodiments, two separate vector embeddings can be created for each node from the graph data: a static embedding and a dynamic embedding. The dynamic embedding can be the embedding that is updated over time to reflect changes of the node (e.g., new edges, time decay for old edges, etc.), as introduced above. The dynamic embedding can represent, at a certain point in time, behavior patterns (e.g., interests and habits) that change over time. The static embedding can be a separate embedding that represents characteristics of a node that do not change over time, or that slowly or infrequently change. For example, a static embedding for a user may represent a date of birth, home address, family relationships, marital status, gender, income level, or any other suitable characteristics. A static embedding can also include an index identifier for a node (e.g., user or resource provider). Each user node and resource provider node can be represented by both a static embedding and a dynamic embedding.

When an interaction takes place, the dynamic embeddings of both end-nodes (e.g., both the participating user node and resource provider node) are updated. In some embodiments, Recurrent Neural Networks (RNNs) can be used to update the dynamic embeddings. A first RNN can be created and trained for user nodes (i.e. RNN_{c}), and a second RNN can be created and trained for resource provider nodes (i.e. RNNₘ). RNN_{c} can be utilized for all user nodes, and RNNₘ can be utilized for all resource provider nodes, according to some embodiments.

For RNN_{c} (which is an example of a first recurrent neural network) and RNNₘ (which is an example of a second recurrent neural network), the input values, weight parameters, and output vector can be represented by the equations shown below.

c(t)=σ(W₁c(t⁻)+w₂m(t⁻)+w₃f+w₄Δt_{c}) (RNN_{c})

m(t)=σ(W₅m(t⁻)+w₆c(t⁻)+w₇f+

[symbol]

These equations indicate how the dynamic embeddings of both a user embedding and a resource provider embedding are updated when the user and resource provider interact at time t. Note that c(t) represents the updated user dynamic embedding as due to the interaction with the resource provider at time t, c(t⁻) is most recent version of the user embedding before the interaction, m(t) is the updated resource provider dynamic embedding as due to the interaction with the user, m(t⁻) is the most recent version of the resource provider embedding before the interaction, f is the feature vector of the current interaction (which can include any suitable number of feature values), Δt_{c} is the time difference between the current time t and the time of the most recent previous interaction for that user or resource provider, σ is a sigmoid function, and each W is a learnable weight parameter. Each capital W (e.g., W₁ and W₅) represent matrices, while each lowercase w (e.g., w₂, w₃, w₄, w₅, w₇ and w₈) represent weights or scaling factors, all of which can be trained using historical interaction data and Recurrent Neural Network techniques (or other machine learning model techniques). The weight parameters effectively determine how much affect a given input has on the transformation of the embedding. For example different features of the feature vector may be more meaningful when determining the updated status and behaviors of a user, and certain aspects of a resource provider (e.g., location, services provided, size) may be more meaningful when determining the updated status and behaviors of a user.

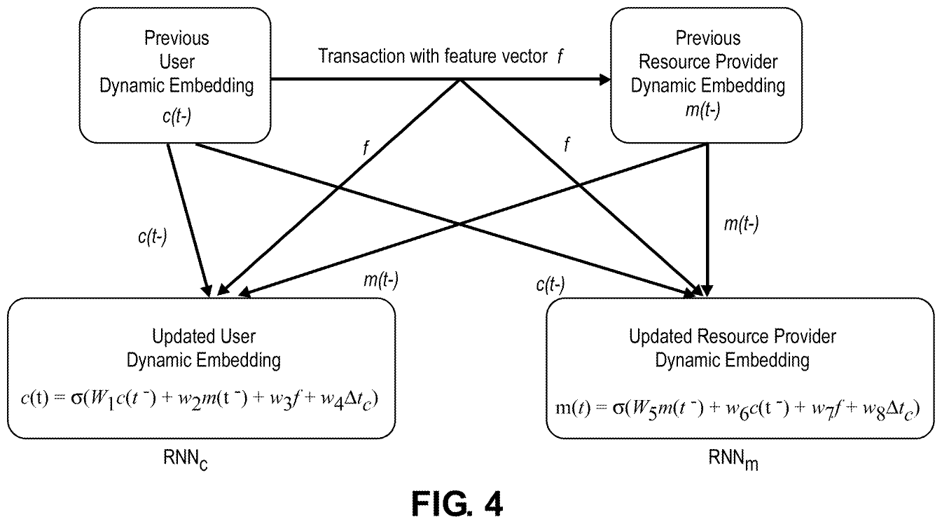

As shown above, RNN_{c} and RNNₘ include the same inputs. However, the weight parameters are distinct and likely to be different after the training process, as users and resource providers may have different tendencies and behavior patterns. RNNₘ for updating the resource provider's dynamic embedding m(t) includes a term for the user's previous dynamic embedding (c(t⁻)), and RNN_{c} for updating the user's dynamic embedding c(t) includes a term for the resource provider's previous dynamic embedding (m(t⁻)). As a result, user dynamic embeddings and resource provider dynamic embeddings can have mutual impacts on each other. This is considered an interdependency between user and resource provider. This relationship is demonstrated in FIG. 4, which illustrates how the same inputs are used for generating both c(t) and m(t).

C. Update Embeddings Based on Ti

[symbol]

In some embodiments, vector embeddings can be updated based on the passage of time, even if new interactions do not take place (e.g., even if new edges are not added to the graph).

For example, a user may not participate in any interactions for a period of time (e.g., 1 hour, 1 day, 3 days, 1 week, 1 month, etc.). However, the behavior of the user may still be considered to have changed over that period of time. For example, if the user purchases a bike, the analysis computer may consider the user to be interested in bikes or bike accessories during a subsequent timeframe. However, if a larger amount of time passes, the amount of the user's interest in bikes or bike accessories can be considered to have decreased or to be less relevant.

An additional neural network (which is an example of a third recurrent neural network) can be used to update the vector representations of nodes in a manner that projects certain effects of the passage of time onto the node. As an example, such a neural network (which is an example of the third recurrent neural network) can be represented by the following projection function for determining a time-updated vector representation:

\tilde{c}(t+Δ)=(1+W·Δ)*c(t)

Here, \tilde{c}(t+Δ) represents a user node's dynamic embedding representation after a time difference A since the time of the user's most recent interaction (e.g., a time-updated vector representation). c(t) represents the most recent version of the user's dynamic embedding as updated at the time of the most recent interaction (e.g., as given by formula RNN_{c} above). (1+W·Δ) is a scalar, trainable parameter value for transforming, in combination with time difference A, the dynamic embedding. This formula can represent a decay in the user's interest in certain products, activities, and/or other associations. W·Δ can be trained to modify certain vector dimensions of c(t) using historical interaction data and Recurrent Neural Network techniques (or other machine learning model techniques). For example different features of the feature vector may be more affected by time decay than others (e.g., location association, shopping category association, etc.).

Accordingly, a dynamic embedding [symbol] be updated for any point in time (e.g., to provide a time-updated vector representation). This can be performed for user node representations and/or resource provider node representations. For example, a similar formula and another set of weight trainable parameters (e.g., another W·Δ) can be provided for resource providers:

\tilde{m}(t+Δ)=(1+W·Δ)*m(t)

With the extracting dataset, and updated versions of the dataset based on new interactions and the passage of time, the analysis computer can perform graph context prediction. Graph context prediction can include determining whether or not a first node will interact with a second node in the future. Illustratively, the analysis computer can determine the next resource provider with which a user will interact, when the interaction takes place, and whether the interaction will be approved or declined. Prediction techniques are discussed below in more detail.

D. Incorporating Neighborhood Information

As described above, a user node dynamic embedding can be affected by a resource provider node dynamic embedding, and vice versa, when the user transacts with that resource provider. In some embodiments, other neighboring nodes can also be considered and included as RNN inputs so that they also have an effect on the user node dynamic embedding.

In some embodiments, a neighbor may not necessarily be embeddings that are close to one another as vectors. Instead, neighbors can be defined based on interaction relationships.

Neighboring nodes can have different levels of separation, such as one hop or two hops. In the context of a bipartite graph, two users are considered to be one-hop neighbors if they have both transacted with the same resource provider. Similarly, two resource providers are considered to be one-hop neighbors if they have both transacted with the same user. In contrast, two-hop neighbors are two users that have not transacted with the same resource provider, but who have a common one-hop neighbor.

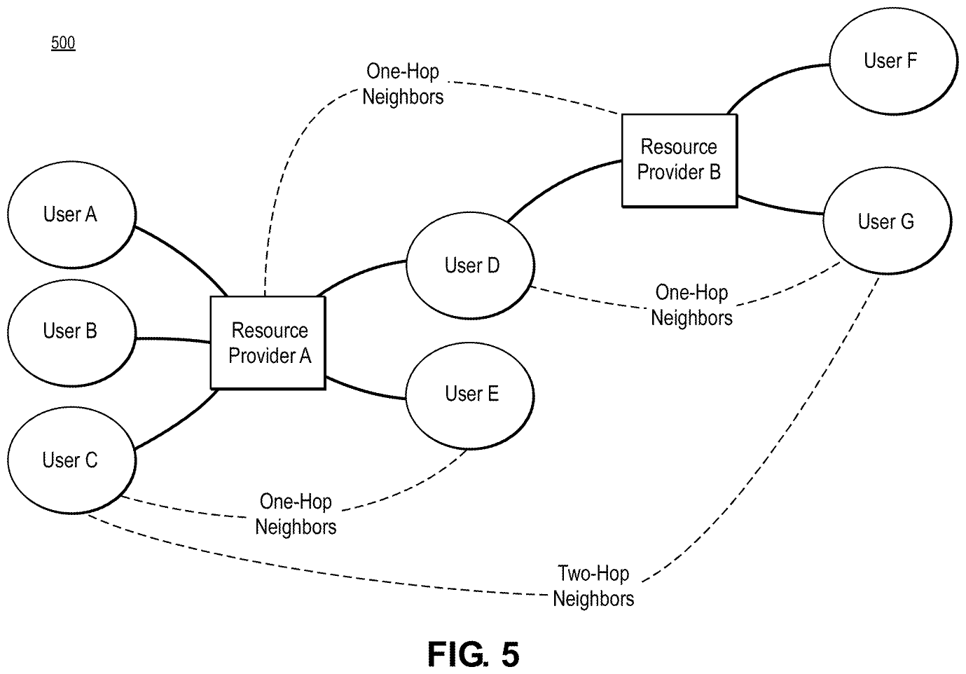

An example bipartite graph 500 illus [symbol] is illustrated in FIG. 5. Cardholder A, B, C, D, and E nodes each have edges connecting to the resource provider A node, which means they have each transacted with resource provider A. Due to each having transacted with resource provider A, all of these five users (A, B, C, D, and E) are one-hop neighbors with one another. For illustrative purposes, FIG. 5 specifically points out that user C node and user E node are one-hop neighbors.

Additional user one-hop neighbor relationships exist for users that have transacted with resource provider B. As shown, user D, F, and G nodes each have edges connecting to the resource provider B node, which means they have each transacted with resource provider B. Due to each having transacted with resource provider B, these three users (D, F, and G) are one-hop neighbors with one another. For illustrative purposes, FIG. 5 specifically points out that user D node and user G node are one-hop neighbors.

Merchant A node and resource provider B node both have edges connecting to the user D node, which means they have each transacted with user D. Due to both having transacted with user D, resource provider A node and resource provider B node are one-hop neighbors, as indicated in FIG. 5.

The bipartite graph 500 in FIG. 5 also includes two-hop neighbor relationships. As shown, user C node and user G node are two-hop neighbors. This is because they have not transacted with the same resource provider (e.g., they are not one-hop neighbors), but they have a common one-hop neighbor (e.g., they are both one-hop neighbors with user D node. In other words, there are two resource provider nodes (e.g., resource provider A and resource provider B nodes) and one user node (e.g., user D node) in between user C node and user G node.

While not specifically indicated in FIG. 5, additional two-hop neighbor relationships are present. For example, similar to user C node discussed above, user A, B, and E nodes are also two-hop neighbors with respect to user G node. Further, user A, B, C, and E nodes are each two-hop neighbors with respect to user F node.

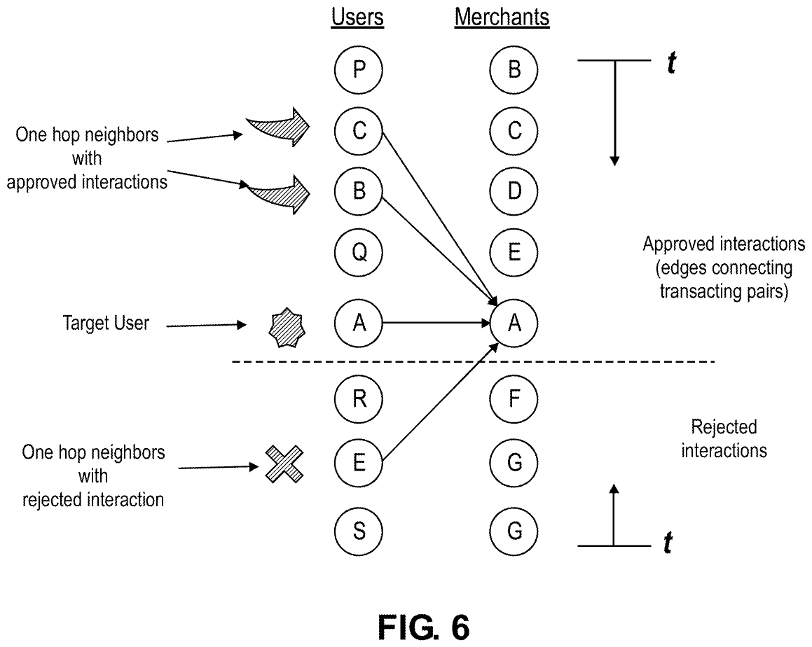

FIG. 6 illustrates a bipartite graph where approved interactions and declined interactions are visually separated. As shown, the dataset can be subdivided into two groups: approved interactions and rejected (or declined) interactions. In this example, the target user A may have one-hop ne [symbol] provider A, where some of the neighbor interactions were approved and some were declined. Edges are shown for interactions between the resource provider A and users A, B, C, and E. The interactions of users B and C were both approved, while the interaction of user E was declined. Approval and declined outcomes can affect the feature vector and embeddings of users, resource providers, and neighbors, as discussed above.

A user's behaviors, such as which resource providers a user interacts with directly, can be analyzed to identify trends. In addition, the user may be similar to other neighbor users in some regards. Accordingly, the behavior of the user's neighbors can also be analyzed to identify trends, and these neighbor trends can provide further insight into the user's behavior patterns and possible future activity.

In order to utilize neighbor node information, embodiments can further include neighbor node embedding information as inputs for the RNN formulas, or otherwise for determining an updated user node dynamic embedding. In some embodiments, the user's one-hop neighbors that were already one-hop neighbors before the time of a target interaction can be identified. The dynamic embeddings of these one-hop neighbors can then be aggregated.

To aggregate the dynamic embeddings of the one-hop neighbors, embodiments of the invention can utilize one of two different aggregation methods. As a first option, average of the identified embeddings can be calculated. As a second option, the weighted average of the identified embeddings can be calculated. When the weighted average is used, the weights of each dynamic embedding can be based on how recent the one-hop neighbor interacted with the common resource provider. If the interaction was more recent in time, the weight of that embedding is larger and the influence of that embedding on the average is larger. In some embodiments, the weight of an embedding is determined by the following formula:

Weight=1/1(target interaction time−neighbor interaction time)

where the target interaction time is the time of current user-resource provider interaction that is being analyzed or used to update the user embedding and/or resource provider embedding, and the neighbor interaction time is when the neighbor previously transacted with the same resource provider. As a result, the most recent neighbor interactions, which may be considered the most r [symbol] determining an updated embedding for a certain user or resource provider.

The aggregated one-hop neighbor embedding vector can be included in the formulas for determining updated dynamic embeddings of users and resource providers. The aggregated one-hop neighbor embedding vector may be added to (e.g., concatenated with) the current user embedding vector before the current user embedding vector is modified by the weight W1. For example, in some embodiments, the RNN equations used for updating the user's dynamic embedding c(t) and resource provider's dynamic embedding m(t) in response to a new interaction (which are examples of the first recurrent neural network and the second recurrent neural network) can take the form shown below:

c(t)=σ(W₁(c(t⁻)+n_{c}(t⁻))+w₂m(t⁻)+w₃f+w₄Δt_{c}) (RNN_{c})

m(t)=σ(W₅(m(t⁻)+nₘ(t⁻))+w₆c(t⁻)+w₇f+w₈Δt_{c}) (RNNₘ)

where n_{c}(t⁻) is the aggregated one-hop neighbor embedding vector for the user node (e.g., the one-hop neighbors as modified by time-based weights, as discussed above) at the time of or just before the current interaction, and where nₘ(t⁻) is the aggregated one-hop neighbor embedding vector for the resource provider node at the time of or just before the current interaction. These more complex versions of the RNN equation are similar to those discussed above for updating the user's dynamic embedding c(t) and resource provider's dynamic embedding m(t), but with the additional inputs of the neighbor embeddings. Accordingly, these can also be used as the first recurrent neural network and the second recurrent neural network, respectively.

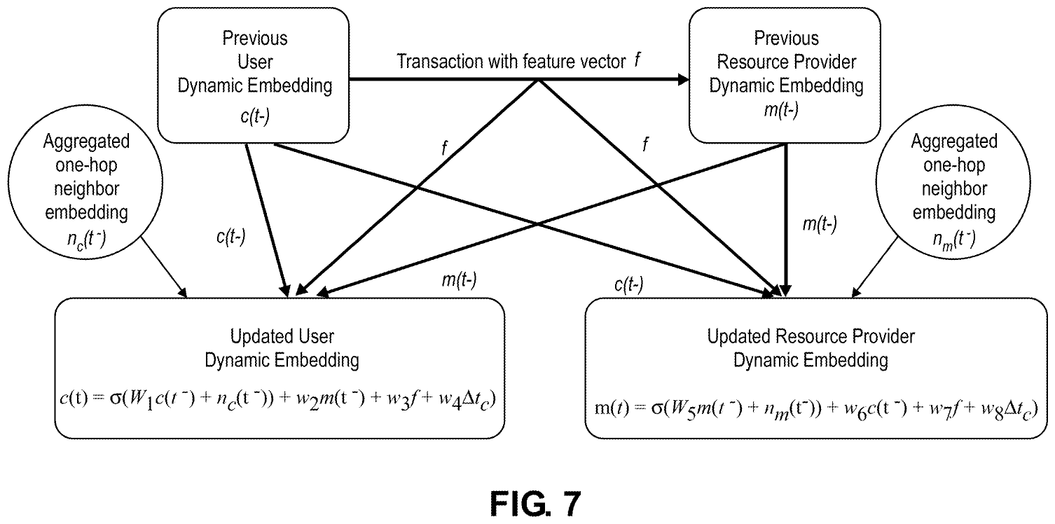

FIG. 7 illustrates how some of the same inputs are used for generating both c(t) and m(t), while different aggregated one-hop neighbor embedding vectors are input for c(t) and m(t) based on their respective one-hop neighbor groups.

Further embodiments can include a separate term for aggregated two-hop neighbors, in addition to and/or instead of the term for aggregated one-hop neighbors. Any suitable number of terms for any suitable distance of neighbors (e.g., three-hop neighbors, four-hop neighbors, etc.) can be included.

Accordingly, the dataset of user and resource provider node embeddings can be updated using RNN equations that are based on new interactions, the passage of time, the status of neighbor node embeddings, [symbol] information. At any suitable time, predictions can be made based on the update embedding data, as discussed below.

### VI. Predicting a Future Transaction

According to some embodiments, the analysis computer can use the embedding vectors, which can be iteratively updated based on new information, as described above, to predict a next interaction.

The analysis computer may specifically predict which resource provider (e.g., by indicating a resource provider embedding) a user will interact with, as well as when the interaction will take place. In other embodiments, the analysis computer may more generally predict the probability of that the user will conduct an interaction somewhere (e.g., across all resource providers).

In one example, the analysis computer can utilize an additional neural network (which is an example a fourth recurrent neural network) that is trained to transform an input user (or resource provider) node embedding into an output of a resource provider (or user) node embedding. The output embedding can represent a prediction for the next resource provider with which the user will interact (which is an example of a first prediction). In some embodiments, the prediction neural network (which is an example of a fourth recurrent neural network) can be represented by the following formula:

ñ(t)=W₉(\tilde{c}(t+Δ))+B

Here, NO represents a predicted resource provider embedding (e.g., with which the user is predicted to interact), W₉ is a learnable matrix parameter, and B can be the user static embedding and/or a static embedding for a previous resource provider (e.g., with which the user most recently interacted).

To explain the factors considered in this prediction (which is an example of the first prediction), some of the previous node embedding update functions from above will be recalled again here. For example, as discussed above, the RNN equation for calculating the updated user embedding c(t) (which is an example of a first recurrent neural network) can be:

c(t)=σ(W₁(c(t⁻)+n_{c}(t⁻))+w

[symbol]

This updates the user node embedding when a new interaction takes place. Inputs to the equation include the user node embedding c(t⁻) as it was before the current interaction, a term for the resource provider node embedding m(t⁻) of the resource provider with which the user is interacting (also as it was before the current interaction), a term n_{c}(t⁻) for the user's neighboring node embeddings (e.g., one hop and or two hop), a term for the feature vector f describing the current interaction, and a term for the amount of time Δt_{c} since the user's previous interaction. These inputs are included as they may provide meaningful information about the current status of the user (e.g., interests, location, and other interaction behavior trends). The inputs will also carry forward into the prediction function through c(t).

The updated user embedding c(t) is determined when an interaction takes place. However, the prediction function may be utilized or regularly checked during times when interactions are not actively taking place. Accordingly, as discussed above, the projection function can be utilized to determine a projection (e.g., a time-updated version) of the user node embedding during times between interactions (e.g., such as a current time when a prediction is being performed):

\tilde{c}(t+Δ)=(1+W·Δ)*c(t)

This projection function (which is an example of a third recurrent neural network) includes a term for the updated user embedding c(t). Accordingly, the projection function effectively incorporates all of the information that is used to determine c(t), such as c(t⁻), m(t⁻), n_{c}(t⁻), and f.

Finally, as mentioned above, the prediction function (which is an example of a fourth recurrent neural network) for predicting a resource provider node embedding for the next resource provider with which the user will interact (which is an example of a first prediction) can take the following form:

ñ(t)=W₉(\tilde{c}(t+Δ))+B

This prediction RNN equation uses the projected user embedding \tilde{c}(t+Δ) as an input. Therefore, prediction function effectively incorporates all of the information that is used to determine \tilde{c}(t+Δ), such as c(t), which itself is based on c(t⁻), m(t⁻), n_{c}(t⁻), and f. The prediction function also includes B, which can be one or more of the user node static embedding and/or the previous [symbol] which the user most recently interacted) static embedding. Thus, in total, the prediction function can be based on embedding and interaction information such as c(t⁻), m(t⁻), n_{c}(t⁻), f, and B, in addition to learnable weight parameters. This may be referred to as a fully connected layer, as several key input components are utilized together.

The prediction function can transform the projected user embedding \tilde{c}(t+Δ) with W₉ and B to produce a predicted resource provider embedding (e.g., a predicted vector). W₉ can be trained using historical interaction data and Recurrent Neural Network techniques.

The resulting predicted embedding (or predicted vector) is the prediction of the next resource provider with which user will interact. The predicted embedding vector may not exactly overlap with or correspond to an actual resource provider embedding for a real resource provider. Accordingly, the analysis computer may then identify a real embedding for a real resource provider that is the most similar (e.g., closest) to the predicted embedding vector. The closest real resource provider embedding may be identified using local sensitivity hashing (LSH). The identified resource provider embedding may then be chosen as the actual predicted resource provider with which the user will interact in the future.

The prediction can be used fora number of tasks. For example, the analysis computer can send a notification message to the resource provider informing that a certain user may visit in the near future. The resource provider may prepare goods, services, incentive coupons, a restaurant table, or any other suitable items for the user before the user arrives. Further, additional information may be gathered about the predicted interaction, such as a success outcome prediction or other suitable features about the interaction, as discussed below.

### VII. Predicting an Interaction Outcome

According to some embodiments, in addition to predicting the next resource provider with which the user will transact, the outcome status of that possible future interaction (e.g. approval or declined) between that specific user and resource provider can also be predicted.

In one example, the analysis comp [symbol] network (which is an example of a fifth recurrent neural network) that is trained to transform an input that includes the latest updated version of the user node embedding c(t) and the predicted next resource provider node embedding m(t). The interaction feature prediction neural network (which is an example of a fifth recurrent neural network) can provide an output vector that describes the interaction features of the predicted interaction (which is an example of a second prediction) between the user and resource provider. In some embodiments, the interaction feature prediction neural network (which is an example of a fifth recurrent neural network) can be represented by the following formula:

s(t)=W₁₀(c(t)+m(t))+B

Here, s(t) represents a predicted interaction vector (which is an example of a second prediction) with feature dimension values (e.g., an amount, a time, a location, an interaction mode, types of goods or services, etc.) for a predicted interaction between that specific user and resource provider. W₁₀ is a learnable matrix parameter that can be trained using historical interaction data and Recurrent Neural Network techniques. B can be the user node static embedding and/or the predicted resource provider node static embedding. As shown in the interaction feature prediction function, the user node embedding and the resource provider node embedding are combined (e.g. concatenated) before being modified by W₁₀.

Once the predicted interaction vector s(t) is obtained, it can be used as an input into a probability function. The probability function (which is an example of a sixth recurrent neural network) can be used to predict whether the predicted interaction with those given vector feature dimension values will have an outcome of approval or denial (which is an example of a third prediction):

p₁=δ(W₁₁s(t))

Here, p₁ is the probability of approval, W₁₁ is a learnable matrix parameter, and δ is a normalization term. W₁₁ can be trained using historical interaction data and Recurrent Neural Network techniques. The output p₁ may take the form of a calculated probability of approval between 0% and 100%.

The analysis computer can take an [symbol] of the probability prediction (which is an example of a third prediction), as well as the features of the predicted interaction (which is an example of a second prediction). For example, the analysis computer may notify the resource provider when an interaction is predicted to take be attempted and declined. The resource provider may then choose to not submit the interaction for approval, and thereby save processing resources and costs. The analysis computer may, in some embodiments, advise the resource provider of later time to submit one or more interaction requests (e.g., through an authorization request message) when there may be a higher chance of approval. Further, the analysis computer can advise the resource provider about other interaction features, such as the items purchases, so that the resource provider can ensure items are in stock and available and/or prepare the items for pickup. A number of other pre-emptive actions can be taken based on the predictions which may improve efficiency and prevent undesirable events (e.g., fraud).

Predicting the next resource provider and interaction outcome can be used for a number of applications. For example, a resource provider can be notified or warned about interactions that may occur. This can happen at any suitable time (e.g., daily in the morning, weekly, monthly, hourly, etc.). The resource provider can be informed about which interaction may and may not be approved. This can allow the resource provider to take an appropriate action, such as submit or not submit an interaction request. In the case of card-on-file resource providers that process recurring (e.g., monthly subscription) interactions for certain users, that resource provider can be advised as to when to submit the recurring charges. For example, it is possible that certain user's purchases may be more likely to be rejected or approved at certain time. For example, Mondays may have higher rejections, while Wednesdays may have higher approvals. As another example, early in the month may have more approvals while later in the month may have more rejections. These types of recommendations can be sent to a resource provider, as well as real-time updates and real-time feedback for interactions currently being processed. As a result, resource providers can better avoid retry of declined interactions and improve their approval rate system. Also, predictions of next actions, outcomes, and interests can enable a stronger recommendation system.

In further embodiments, the chance [symbol] (e.g., in a certain area) can be determined. The interaction feature prediction function can be used to predict features of various interactions between the user and every resource provider (e.g., within a given physical area). Then each the interaction vectors can be input into the transaction probability outcome function (which is an example of a sixth recurrent neural network), and all of the resulting probabilities can be considered together to determine the likelihood that the user will conduct an interaction somewhere (e.g., within a certain area and timeframe).

### VIII. Loss Function

A dataset of past interactions can be used as training data. The RNN equations described above can be trained using some interaction data, and then tested using the same or different interaction data. During testing, the analysis computer uses the RNN equations to attempt to predict the next resource provider with whom a user will transact (or the next user with whom a resource provider will transact), as well as the interaction outcome. The RNN output can be a certain embedding. In the testing case (as opposed to real-world implementation), the actual resource provider embedding for the resource provider with whom the user actually transacted is already known from the test data (e.g., historical interaction data), as is the interaction outcome. Accordingly, the predicted embedding can then be compared with the actual resource provider embedding and the actual outcome. For example, the historical interaction data can be divided into various timeframes. An initial timeframe can be used to create the initial embeddings, and interaction data that takes place after that initial timeframe can be used for updating embeddings and comparing predictions with actual outcomes. The accuracy of the predicted embedding can be measured using a loss function (also referred to as a loss formula or error function). The analysis computer can iteratively train and update the RNN equations by minimizing the loss calculated by the loss function (e.g., using gradient descent methods).

An example loss function (LF) is shown below:

LF=Σ∥ñ(t)−m(t)∥₂+(−t₁ log(p₁)−(1−t₁)log(1−p₁))+λc∥c(t)−c(t⁻)∥2+λm∥m(t)−m(t⁻)∥2

This loss function includes a number of terms, each designed to train one or more of the RNN equation discussed above.

For example, in the first term of the [symbol] predicted resource provider embedding and m(t⁻) is the actual observed resource provider embedding (e.g., as indicated by the test data). The first term in loss function (e.g., ñ(t)−m(t⁻)) determines the difference between the predicted resource provider embedding to the true resource provider embedding. Due to this term being included in the loss function, the formula for predicting the next resource provider embedding will be trained to minimize this difference. Thus, the trainable weight parameters discussed above for predicting a next resource provider embedding can be trained through the loss function and historical interaction test data.

Further, in the second term of the loss function, p₁ represents the probability of interaction success, which is based on both the user embedding and the resource provider embedding as discussed above. The second term in loss function (e.g., −t₁ log(p₁)−(1+t₁) log(1−p₁)) is a binary cross entropy loss term, and it is included to minimize the error in interaction outcome prediction task, which is a binary classification task. Due to this term being included in the loss function, the formula for predicting the interaction outcome will be trained to minimize this error. Thus, the trainable weight parameters discussed above for predicting the interaction outcome can be trained through the loss function and historical interaction test data.

The loss function includes a first term related to the accuracy of the predicted resource provider embedding, and a second term related to the accuracy of the predicted interaction outcome. As a result, the analysis computer can learn multiple tasks (e.g., predict resource provider and predict outcome) at the same time through the same loss function. Also, because the prediction functions are fully connected to other RNN equations, the entire set of RNN equations (e.g., their weight parameters) can be trained through this loss function.

In some embodiments, the loss function can be changed or separated in order to learn just one of the tasks. For example, if it is desired to only predict the resource provider embedding and not the interaction outcome, the second term can be removed from the loss function. Alternatively, if it is desired to only predict the interaction outcome and not the resource provider embedding, the first term can be removed.

The last two terms in the loss function are for smoothing the RNN equations for updating the user embedding c(t) and resource provider embedding m(t).

For example, the third term (e.g., Δc∥c(t)−c(t⁻)∥ [symbol] the updated user embedding c(t) and the previous user embedding c(t⁻), and the fourth term (e.g., λm∥m(t)−m(t⁻)∥2) determines the difference between the updated resource provider embedding m(t) and the previous resource provider embedding m(t⁻). By including these terms in the loss function, the RNN equations will be trained to avoid large changes when updating the embeddings.

### IX. Example Method

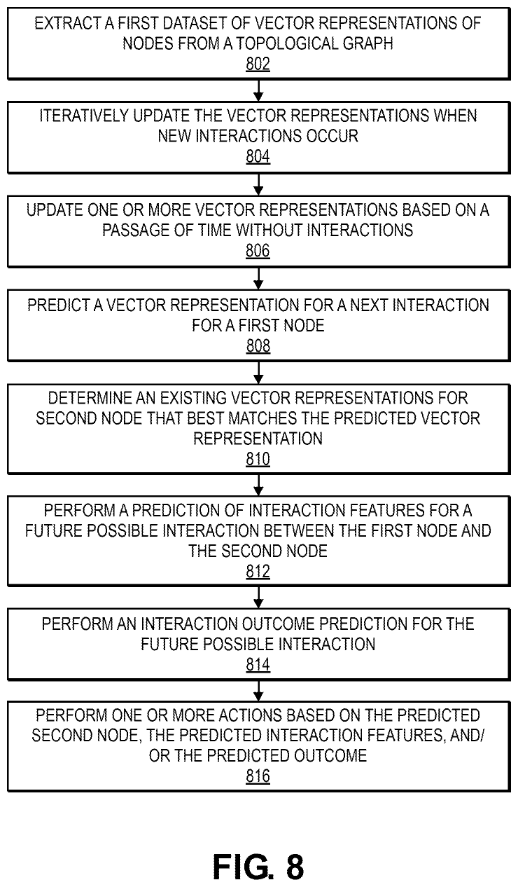

FIG. 8 shows a flow diagram illustrating a dynamic graph representation process according to some embodiments. The method illustrated in FIG. 8 will be described in the context of an analysis computer analyzing interaction graph data. It is understood, however, that the invention can be applied to other circumstances (e.g., analyzing other types of graph data, etc.). In some embodiments, each graph snapshot of the plurality of graph snapshots can comprise a plurality of nodes. Each graph snapshot of the plurality of graph snapshots can include graph data associated with a timestamp.

At step 802, the analysis computer can extract a first dataset from a bipartite graph of interaction data using a graph structure learning module. The first dataset can include initial vector representations for each node the graph based on interaction graph data for an initial timeframe (e.g., a first day, week, month, year, etc.). In some embodiments, extracting the first dataset may also include performing a structural self-attention process for graph data of an initial timeframe.

At step 804, the analysis computer can iteratively update the vector representations for each node as new interactions take place. In some embodiments, iteratively updating the vector representations can be performed using one or more RNN equations with weight parameters trained using historical transaction data. The RNN equations can incorporate inputs that may provide insight as to the behaviors and status of the nodes. For example, a user node vector representation may be updated when a new interaction takes place. The user node vector representation may be updated based on inputs including the current version of the user node vector representation, a feature vector representing a new interaction taking place, the current version of a resource provider node vector representation for a resource provider with whom the interaction is being conducted, one or more neighboring node vector representations, the time since a previous intera [symbol] suitable information. A separate trained RNN equation can be used to update resource provider nodes in a similar manner. Accordingly, the vector representations, which can be embeddings of each node in a vector space representative of characteristics of the plurality of nodes, can be iteratively updated.

At step 806, the analysis computer can update a vector representation for one or more nodes based on an amount of time that has passes since a previous interaction and vector update. For example, it may be desired to determine an updated user node vector representation for a certain user, even when a new interaction is not taking place, in order to make a prediction about a subsequent user interaction. An RNN equation with weight parameters trained using historical transaction data can be used to update the user node vector representation based on a passage of time without interactions during that time (e.g., determine a time-updated vector representation).

At step 808, the analysis computer can determine an embedding representing a resource provider node that the user is predicted to interact with next. An RNN equation with weight parameters trained using historical transaction data can be used to predict the resource provider node vector representation based on the projected version of the user node vector representation (e.g., as determined in step 806).

At step 810, the analysis computer can determine an actual resource provider node vector representation that most closely matches the predicted embedding from step 808. For example, the predicted embedding (e.g., as determined in step 808) may not exactly overlap with or correspond to an actual resource provider node vector representation for a real resource provider. The closest real resource provider node vector representation may be identified using local sensitivity hashing (LSH), in some embodiments. The identified closest resource provider node vector representation may then be chosen as the actual predicted resource provider with which the user will interact in the future.

At step 812, the analysis computer can perform an interaction prediction based on the user node vector representation and the predicted resource provider node vector representation (e.g., as determined in step 810). For example, an RNN equation with weight parameters trained using historical transaction data can be used to predict the features of a possible future interaction (e.g., a future edge in the bipartite graph) between the user and predicted resource provide [symbol] the user node vector representation and the predicted resource provider node vector representation as inputs, and can produce an output of interaction feature vector values.

At step 814, the analysis computer can perform an interaction outcome prediction. For example, an RNN equation with weight parameters trained using historical transaction data can be used to predict, for the predicted interaction feature vector (e.g., as determined in step 812), whether an interaction with those features will be approved or declined. The analysis computer may determine a probability of whether the interaction will be approved.

At step 816, the analysis computer can take on or more actions based on one or more of the predictions. For example, the analysis computer can inform the predicted resource provider about features of the predicted interaction and/or predicted approval probability of the interaction. In some embodiments, the analysis computer may send a notification if the probability of approval is below a certain threshold, indicating that interaction decline is sufficiently likely to merit a warning. The analysis computer may also recommend a time when the interaction is more likely to be approved. The resource provider may receive such a notification, and determine whether to process the interaction when the user attempts to conduct the interaction.

### X. Experiments and Results

From the historical data, the first 80% of sorted data can be used for training, the next 10% of sorted data can be used for validation, and the last 10% of sorted data can be used for testing.

The first task can be predicting the next resource provider. The metrics reported can be: Mean Reciprocal Rank (MRR), and Recall@10.

In order to calculate the metrics:
1) For every query, the user is known, and the goal is to predict the next resource provider embedding.
2) After predicting the resource provider embedding, Euclidean distances are calculated between the predicted embedding and all other resource provider embeddings using LSH technique. The resource provider embeddings are sorted based on the calculate distances to find the rank of ground-truth resource provider (e.g., the true reso [symbol] historical data) in the result list. The ratio (1/rank) provides the reciprocal rank of the query. Averaging this over all queries provides Mean Reciprocal Rank (MMR).
3) For Recall@10, the ratio of test cases in which the ground truth resource provider is ranked in the top 10 resource providers of the sorted list is reported. A higher ratio indicates a better test result and more accurate process, as the correct resource provider is being identified.

TABLE 4
Result table for task 1 for validation and test sets

| Metrics | Validation | Test |
|---|---|---|
| Recall@10 | 93.77 | 94.35 |
| MRR | 92.34 | 92.76 |

The second task can be a classification task. Here the recall, precision, F-score and AUC are reported. Training can take place of 50 epochs.

TABLE 5
Results for task 2, for vanilla model, and extended models
with 2 hop neighbors and weighted 2 hop neighbors

| | 1 hop only | | 2 hop | | Weighted 2 hop | |
|---|---|---|---|---|---|---|
| | Best Model | | Best Model | | Best Model | |
| | Valida- | | Valida- | | Valida- | |
| | tion | Test | tion | Test | tion | Test |
| AUC | 95.14 | 95.90 | 94.83 | 95.69 | 94.81 | 95.65 |
| Recall-class 0 | 85.64 | 86.86 | 85.36 | 86.62 | 85.00 | 86.97 |
| Recall-class 1 | 94.32 | 95.62 | 93.87 | | | |
| precision-class 0 | 94.16 | 95.92 | 93.70 | 95.71 | 94.29 | 95.61 |
| precision-class 1 | 86.01 | 85.99 | 85.71 | 85.74 | 85.49 | 86.04 |
| f-score- class 0 | 89.70 | 91.17 | 89.34 | 90.94 | 89.40 | 91.09 |
| f-score - class 1 | 89.97 | 90.55 | 89.61 | 90.31 | 89.77 | 90.42 |

Embodiments of the invention advantageously provide a method for updating node embeddings as a dynamic temporal bipartite graph changes over time, and thereby leverages time information from the dynamic temporal graph. By training RNN equations with strategic input values, meaningful information about user behavior patterns can be considered, modeled, and used to predict future activities. In turn, prediction of the future can be used to notify interested parties, and more efficiently use processing resources.

A computer system will now be described that may be used to implement any of the entities or components described herein. Subsystems in the computer system are interconnected via a system bus. Additional subsystems include a printer, a keyboard, a fixed disk, and a monitor which can be coupled to a display adapter. Peripherals and input/output (I/O) devices, which can couple to an I/O controller, can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer-readable medium.

As described, the inventive service may involve implementing one or more functions, processes, operations or method steps. In some embodiments, the functions, processes, operations or method steps may be i [symbol] execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a,” “an,” or “the” is intended to mean “at least one,” unless specifically indicated to the contrary.

What is claimed is:

1. A method comprising:
receiving, by an analysis computer, a graph comprising a plurality of user nodes for a plurality of users, a plurality of resource provider nodes for a plurality of resource providers, and a plurality of interaction edges between the plurality of user nodes and the plurality of resource provider nodes, the interaction edges representing a plurality of interactions between the plurality of users and the plurality of resource providers;
extracting, by the analysis computer, a dataset including initial vector representations for each of the plurality of user nodes and for each of the plurality of resource provider nodes;
generating, by the analysis computer, using a first recurrent neural network and an initial vector representation for a first user node from the plurality of user nodes, an updated vector representation for the first user node in response to a new interaction involving the first user node;
performing, by the analysis computer, a first prediction of a future interaction based on the updated vector representation for the first user node; and
performing, by the analysis computer, an action based on the future interaction.

2. The method of claim 1, wherein generating the updated vector representation for the first user node is based on inputs to the first recurrent neural network, where the inputs to the first recurrent neural network include the initial vector representation for the first user node, a vector representation for a resource provider node associated with the new interaction, and features of the new interaction.

3. The method of claim 2, wherein the inputs to the first recurrent neural network further include one or more vector representations corresponding to one or more neighbor nodes of the first user node.

4. The method of claim 3, wherein the one or more neighbor nodes of the first user node include one-hop neighbors or two-hop neighbors.

5. The method of claim 1, wherein performing the first prediction of the future interaction includes:
determining, using a third recurrent neural network, a time-updated vector representation for the first user node based on an amount of time elapsed since a most recent interaction involving the first user node and a current time, wherein the future interaction is predicted based on the time-updated vector representation for the first user node.

6. The method of claim 5, wherein predicting the future interaction includes:
predicting, using a fourth recurrent neural network and the time-updated vector representation for the first user node, a vector; and
determining, a resource provider node from the plurality of resource provider nodes with a vector representation that is closest to the predicted vector, wherein the future interaction is predicted to include the first user node and the determined resource provider node.

7. The method of claim 6, further comprising:
performing, by the analysis computer, a second prediction of features for the future interaction, where the second prediction is performed using a fifth recurrent neural network and inputs to the fifth recurrent neural network including the updated vector representation for the first user node and the vector representation of the determined resource provider node.

8. The method of claim 7, further comprising:
performing, by the analysis computer, a third prediction of an outcome for the future interaction, the third prediction is performed using a sixth recurrent neural network and inputs to the sixth recurrent neural network including the predicted features for the future interaction.

9. The method of claim 8, wherein the predicted outcome for the future interaction is a probability of approval.

10. The method of claim 9, wherein performing the action includes notifying a resource provider associated with the determined resource provider node about at least one of the future interaction, the predicted features for the future interaction, and the probability of approval.

11. The method of claim 10, wherein notifying includes providing a recommendation to take one or more subsequent actions, the subsequent actions including at least one of submitting an interaction for approval when the future interaction is initiated, not submitting the interaction for approval when the future interaction is initiated, and waiting until a recommended later time to submit the interaction for approval.

12. The method of claim 11, wherein the first recurrent neural network, the third recurrent neural network, the fourth recurrent neural network, the fifth recurrent neural network, and the sixth recurrent neural network each include corresponding learned coefficients trained using a machine learning model and known historical interaction data.

13. The method of claim 12, further comprising:
training, by the analysis computer, each of the first recurrent neural network, the third recurrent neural network, the fourth recurrent neural network, the fifth recurrent neural network, and the sixth recurrent neural network using the known historical interaction data.

14. The method of claim 13, wherein the training is based on a loss function that includes a term designed to minimize differences between predicted vectors and corresponding known resource provider vectors.

15. An analysis computer comprising:
a processor; and
a computer readable medium coupled to the processor, the computer readable medium comprising code, executable by the processor, for implementing a method comprising:
receiving a graph comprising a plurality of user nodes for a plurality of users, a plurality of resource provider nodes for a plurality of resource providers, and a plurality of interaction edges between the plurality of user nodes and the plurality of resource provider nodes, the interaction edges representing a plurality of interactions between the plurality of users and the plurality of resource providers;
extracting a dataset including initial vector representations for each of the plurality of user nodes and for each of the plurality of resource provider nodes;
generating, using a first recurrent neural network and an initial vector representation for a first user node from the plurality of user nodes, an updated vector representation for the first user node in response to a new interaction involving the first user node;
performing a first prediction of a future interaction based on the updated vector representation for the first user node; and
performing an action based on the future interaction.

16. The analysis computer of claim 15, wherein the graph is a bipartite graph.

17. The analysis computer of claim 15, wherein each interaction edge from the plurality of interaction edges includes an associated feature vector containing values for one or more features including one or more of an amount, a time, a location, a type, and an outcome.

18. The analysis computer of claim 15, wherein generating the updated vector representation for the first user node is based on inputs to the first recurrent neural network, where the inputs to the first recurrent neural network include the initial vector representation for the first user node, a vector representation for a resource provider node associated with the new interaction, and features of the new interaction.

19. The analysis computer of claim 18, wherein the inputs to the first recurrent neural network further include one or more vector representations corresponding to one or more neighbor nodes of the first user node.

20. The analysis computer of claim 19, wherein the one or more neighbor nodes of the first user node include one-hop neighbors or two-hop neighbors.
